(19) United States
(12) Patent Application Publication
(10) Pub. No.: US 2017/0107820 A1
(43) Pub. Date: Apr. 20, 2017

(54) Turbine wheel for a radial turbine

(71) Applicant: ATLAS COPCO ENERGAS GMBH, Koeln (DE)

(72) Inventor: Lukas Schwarz, Koeln (DE)

(21) Appl. No.: 15/287,874

(22) Filed: Oct. 7, 2016

(30) Foreign Application Priority Data
Oct. 14, 2015 (DE) 102015117470.7

(51) Int. Cl. F01D 5/04; F01D 5/12

(52) U.S. Cl. CPC F01D 5/048; F01D 5/12; F05D 2240/30

(57) ABSTRACT

A turbine wheel for a radial turbine includes a flow chamber delimited by a hub disk and a cover disk. The flow chamber connects an inner opening to an outer opening and is subdivided by a plurality of turbine blades into flow channels. The of the plurality of turbine blades, which are adjacently disposed in a circumferential direction are slanted relative to each other.

CROSS-REFERENCE TO A RELATED APPLICATION

The invention described and claimed hereinbelow is also described in German Patent Application DE 10 2015 117 470.7, filed on Oct. 14, 2015. This German Patent Application, subject matter of which is incorporated herein by reference, provides the basis for a claim of priority of invention under 35 U.S.C. 119(a)-(d).

### BACKGROUND OF THE INVENTION

The invention relates to a turbine wheel for a radial turbine including a flow chamber that is delimited by a hub disk and a cover disk, connects an inner opening to an outer opening and is subdivided by a plurality of turbine blades into flow channels. Such a turbine wheel is provided for a radial turbine in which a working medium flows radially with respect to an axis of rotation of the turbine wheel. The teaching according to the invention also relates, without restriction, to other radial-flow turbine machines, such as, for example, centrifugal fans, centrifugal pumps, and centrifugal compressors.

Turbine wheels having the above-described design also are referred to as cover disk rotors. Cover disk rotors are designed to take have the advantage that a working medium guided through the turbine flows only through the interior of the impeller without having to come in contact with the outer walls of the turbine housing. As a result, greater gap widths between the impeller and the housing are possible without noticeable flow losses, by means of which gap widths, for example, thermal expansions can be absorbed.

Specifically for the use in cases of particularly high rotational speeds, such turbine wheels cannot be designed arbitrarily filigree, however, since considerable loads due to torsional moments and centrifugal forces sometimes occur during operation. Conventional cover disk rotors for high load requirements are therefore typically designed so as to be solid, including reinforced turbine blades, in order to permit these particularly strong forces to be dissipated. Due to the increased amount of material used and the additional mass on the turbine wheel, which results in additional centrifugal forces and also increases the moment of inertia of the turbine wheel, this is associated with considerable disadvantages, however.

### SUMMARY OF THE INVENTION

The present invention overcomes the shortcomings of known arts, such as those mentioned above.

The inventive turbine wheel for a radial turbine increases the stability of the turbine wheel, in particular with respect to torsional loads, and embodies a material-saving design.

According to the invention, two turbine blades that are adjacently situated in the circumferential direction are slanted relative to each other. As a result, the flow cross-section of the flow channels, each of which is delimited by two adjacent turbine blades and by a section of the hub disk and of the cover disk, assumes the shape of a trapezoid. A thus-shaped flow channel has, in combination with an adjacent likewise trapezoidal flow channel, an increased stability as compared to conventional designs. For fluidic reasons, radial turbine wheels known prior to the invention described hereinbelow, always been designed such that adjacent turbine blades are oriented in parallel (i.e., not slanted relative to one another) such that the flow channels therefore form rectangles or parallelograms. These conventional turbine wheels have a low stability with respect to a rotary displacement of the hub disk relative to the cover disk. Due to the inclination according to the invention, an increase in stability is achieved, which outweighs any disadvantages related to the flow guidance.

The cross-sectional shape of the flow channels is arranged perpendicular to the direction of flow of the fluid through the flow channels. For this purpose, a cylindrical lateral surface concentric to the axis of rotation of the turbine wheel, which intersects the turbine wheel in a constant radius, for example, is available as a cut surface. The inclination of two adjacent turbine blades can therefore be compared to each other. The inclination of a turbine blade is referred to as the angle between the extension of the turbine blade and a line lying parallel to the axis of rotation in the cylinder jacket. Two adjacently situated turbine blades are slanted relative to each other when they have different inclinations (with respect to a line parallel to the axis of rotation).

In the case of flow channels or flow channel sections which also extend at a slant partially in the axial direction, at least one embodiment of the invention provides, as the cut surface, a conical surface that is situated with rotational symmetry about the axis of rotation and which intersects the hub disk and the cover disk approximately at a right angle. A straight line which intersects the axis of rotation and lies in the conical surface is to be selected in this case as the reference line for calculating the inclination.

Advantageously, two turbine blades adjacently disposed in the circumferential direction are slanted relative to each other at their outer ends adjoining the outer opening in each case. The greatest loads occasionally occur in this area, and so the reinforcement according to the invention is particularly advantageous here.

In an embodiment, the turbine blades are formed by full blades, which extend from the inner opening to the outer opening, and splitter blades, which start with radial spacing from the inner end of the full blades and extend up to the outer opening.

Due to the arrangement of the splitter blades, the expansion of the flow channels in the radial direction is counteracted by way of the flow channels being subdivided into sub-channels. The smaller cross section of the sub-channels also is advantageous with respect to the flow guidance of the turbine in addition to the stabilization according to the invention, since, as a result, a greater number of stabilizing trapezoidal flow cross-sections can be formed.

In one embodiment, the full blades are straight and the splitter blades are at least partially slanted. Specifically in this context, this means that the full blades do not have an inclination angle, or merely a slight inclination angle of less than 5° at at least one point of their radial extension, preferably at their inner and/or outer end. At least one of the splitter blades situated between two straight full blades is designed so as to be slanted at least in one point of its radial extension, in particular, at its inner and/or outer end. In the case of more splitter blades situated between two straight full blades, individual splitter blades can also be designed so as to be straight.

Preferably, the inclination of a turbine blade can vary in dependence on the distance from an axis of rotation, about which the turbine wheel is rotationally periodically formed. As a result, the geometry of the flow channels, in the extension from the inner opening to the outer opening, can be adapted to the requirements with respect to the flow properties and the stability. In this way, for example, the flow channel is delimited at one end by two sections of two adjacent turbine blades, which are parallel, i.e., not slanted relative to each other, while the turbine blades at the other end of the flow channel are slanted relative to each other in order to increase the stability.

Advantageously, the flow cross-section of a flow channel along the entire length of the flow channel is the same size as the flow cross-section of an adjacent flow channel in each case. This is achieved by suitably selecting the spacing and inclination of the turbine blades limiting the adjacent flow channels, for every point in the radial extension of the flow channels. As a result, a uniform flow load is ensured despite the inclination.

According to another embodiment, the hub disk and/or the cover disk are/is curved in the radial direction. As a result, it is possible, for example, to connect the inner opening of the flow chamber to an axially parallel feed of the flow medium and to withdraw the flow medium at the outer opening, in the radial direction. Due to a resultant curved shape of the flow chamber, an efficient and favorable redirection from the axial direction of flow to the radial direction of flow is achieved.

In order to provide additional stabilization, the turbine blades are arranged to transition, in a rounded overhang, into the cover disk. This is additionally advantageous in the case of manufacturing of the turbine wheel by additive production methods, in accordance with the invention.

Preferably, the turbine blades are arranged n-periodically having a natural number n greater than or equal to two. This means that every turbine blade has the same inclination as the next turbine blade following in the nth position in the circumferential direction, and all turbine blades situated therebetween have an inclination which deviates therefrom.

### BRIEF DESCRIPTION OF THE DRAWING FIGURES

The invention is explained in greater detail in the following drawings with reference to at least one exemplary embodiment. Schematically in the drawings:

FIG. 1 presents a side view of a partially cutaway turbine wheel according to the invention,

FIG. 2 presents a top view of a turbine wheel according to the invention, along the axis of rotation, with the cover disk removed,

FIG. 3 presents a partial view of the mouth opening from FIG. 1,

FIG. 4 presents a side view of a turbine wheel according to the invention, according to an alternative exemplary embodiment, and

FIG. 5 presents a schematic top view of the turbine wheel from FIG. 4, with the cover disk removed.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

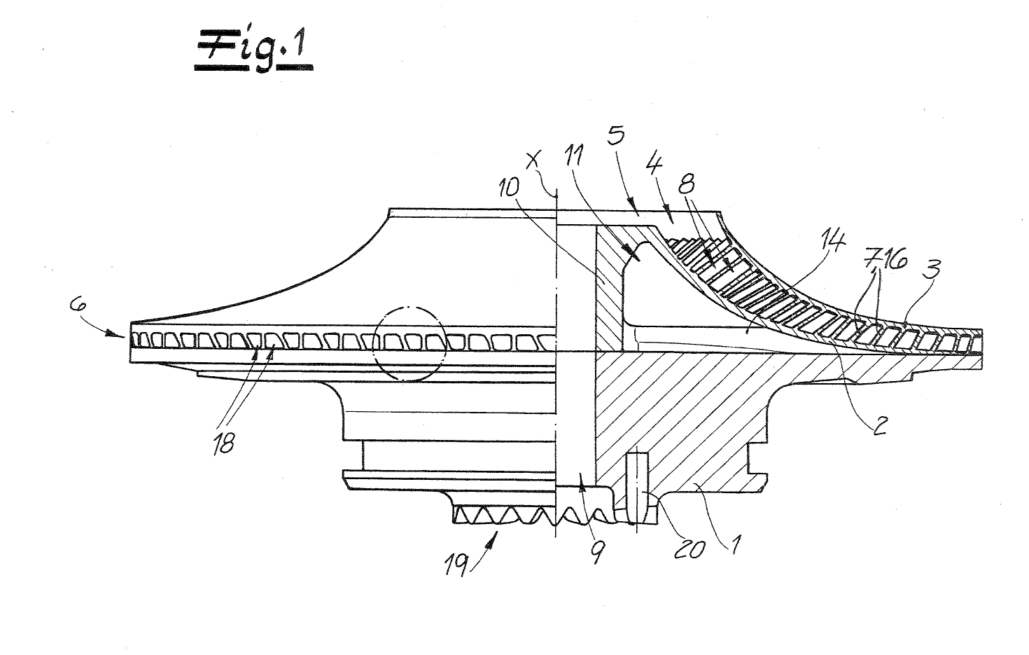

FIG. 1 presents a turbine wheel constructed according to the invention. The inventive turbine wheel comprises a base plate 1 that has rotational symmetry about an axis of rotation x. Situated thereon is a flow chamber 4 that is delimited by a hub disk 2 and a cover disk 3. This flow chamber connects an axial inner opening 5 to a radial, circumferential, outer opening 6 of the turbine wheel. As is apparent on the radial cut surface, both the cover disk 3 as well as the hub disk 2 are formed having a substantially constant thickness in the extension from the inside to the outside. The hub disk 2 has a greater thickness than the cover disk 3 and transitions into the base plate 1 in the radially outer area. The flow chamber 4 is subdivided by turbine blades 7, 16 into flow channels 8, 18.

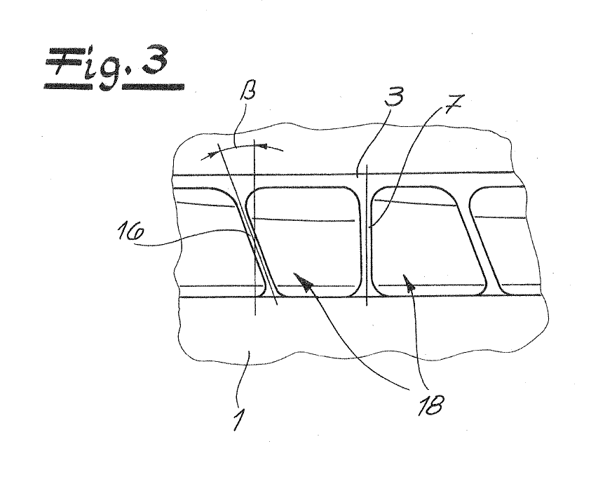

According to the invention, the turbine blades 7, 16 are slanted relative to each other at the outer opening 6, as is apparent in FIG. 1 and, in particular, in FIG. 3.

The base plate 1 has a central hub passage 9 that is adjoined by a sleeve-shaped, central section 10 of the turbine wheel. The central section 10, the hub disk 2 and the base plate 1 enclose a hollow space 11. This hollow space has openings 12 that are situated on a flange-shaped section 13 formed by the axial end of the central section 10 and the hub disk 2 and located within the inner axial opening 5 of the flow chamber.

Power transmission ribs 14 are situated within the hollow space 11. The power transmission ribs extend from the central section 10 to the back side of the hub disk 2 which faces away from the flow chamber 4 and encloses the hollow space 11.

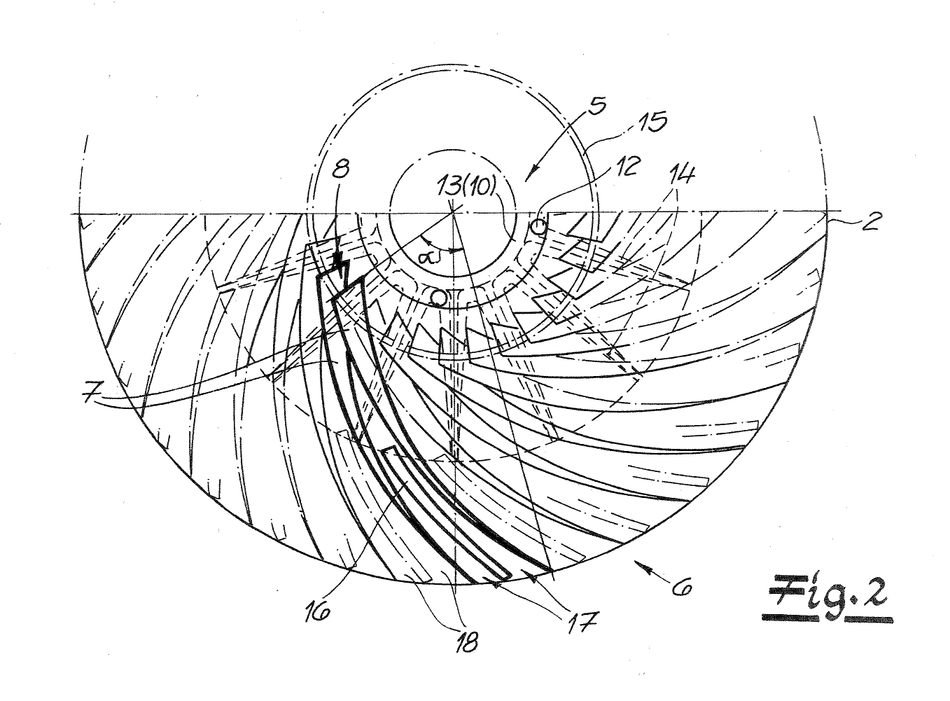

The cover disk 3, which would otherwise obscure the flow chamber 4 in the axial top view, is not shown in FIG. 2, for the sake of improved clarity. For the purpose of orientation, the ring 15 enclosing the axial inner opening 5 is merely indicated using a dash-dotted line. The turbine blades 7, 16 are formed by full blades 7, which extend from the inner opening 5 to the outer opening 6, and splitter blades 16, which start with radial spacing from the inner end of the full blades 7, extend up to the outer opening 6. The flow channels 8, 17 delimited by the turbine blades 7, 16 are apparent therebetween.

In the embodiment shown, only one splitter blade 16 is provided between two full blades 7 in each case. Please note Multiple splitter blades 16 also can be situated in this intermediate space, as necessary. For the sake of improved understanding, a single, arbitrarily selected area between two full blades 7 is shown with emphasis and is provided with reference numbers. The remaining turbine blades 7, 16 are merely indicated using a dash-dotted line.

The full blades 7 and the splitter blades 16 extend in an arcuate shape. The offset a between the inner end of a full blade 7 and its outer end is approximately 60° in this case. Furthermore, the openings 12 leading into the hollow space 11 are shown in the figure. The power transmission ribs 14, which are situated in the hollow space and are largely covered by the hub disk 2, are indicated merely as dashed lines. A comparison of FIGS. 1 and 2 reveals that, in this exemplary embodiment, the power transmission ribs 14 are designed so as to each taper away from the central section 10 and the base plate 1.

In FIG. 1, the substantially rotationally symmetrical base plate 1 has a channel toothing 19 on its end spaced apart from the flow chamber 4, for reliably coupling to a shaft. Furthermore, a bore 20 for accommodating a fixing screw is apparent in the cut half. As is clear from the left half of FIG. 1 and FIG. 3 (which shows an enlarged section of the outer opening 6), the full blades 7 and the splitter blades 16 are slanted relative to each other in such a way that the mouth openings 18 of the flow channels 17 are delimited by alternatingly slanted and axially parallel-oriented wall surfaces. The transitions between the wall surfaces and the cover disk are designed so as to be rounded. As indicated in FIG. 3, the splitter blade 16 is slanted by an angle β relative to a line lying parallel to an axis of rotation x. The full blade 7, however, is situated so as to be straight, i.e., parallel to the axis of rotation x. The two adjacent mouth openings 18, each of which represents the cross section of the flow channels 17, have cross-sectional areas of approximately the same size.

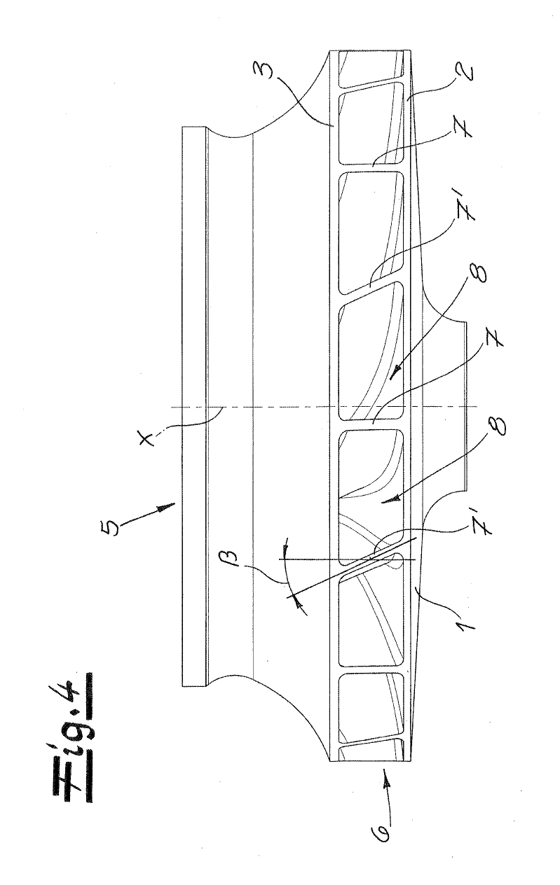

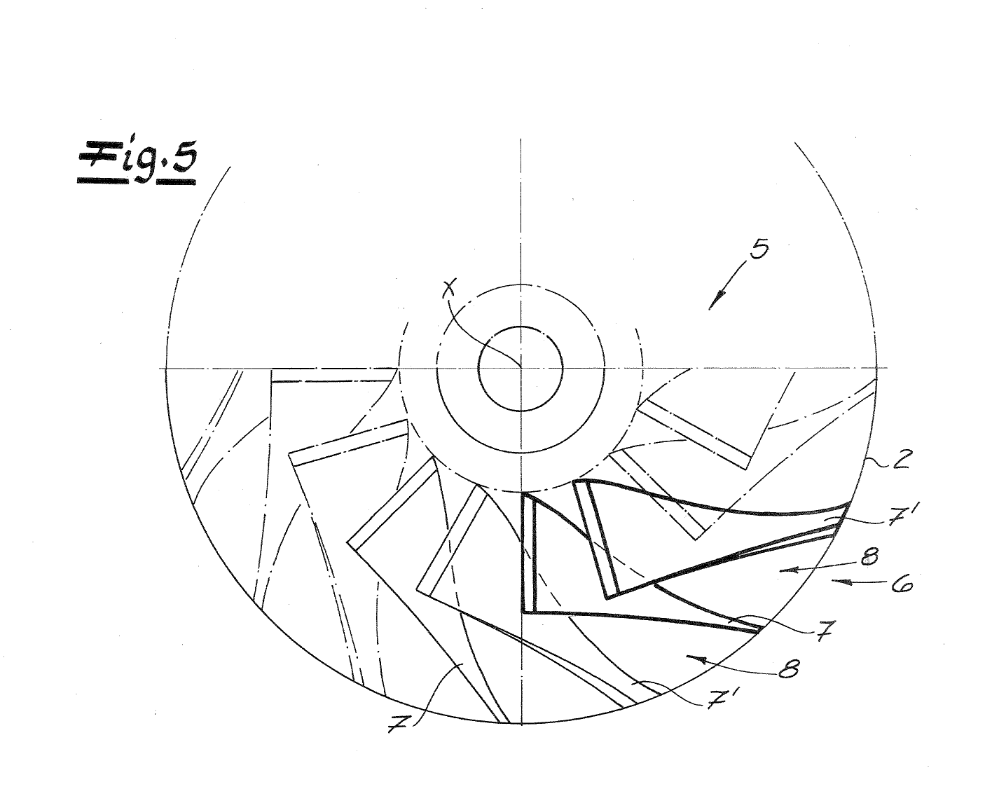

A further embodiment is shown in FIGS. 4 and 5. The turbine wheel likewise has a flow chamber delimited by a hub disk 2 and a cover disk 3. This flow chamber likewise connects an axial inner opening 5 to a radially circumferential outer opening 6. As is clear from FIG. 5, the turbine blades are formed exclusively by full blades 7, 7′, which extend continuously from the inner opening 7 to the outer opening 6. These full blades 7, 7′ subdivide the flow chamber 4 into flow channels 8.

Two turbine blades 7, 7′ adjacently disposed in the circumferential direction are slanted relative to each other in this case. As is clear from FIG. 4, turbine blades 7 having a straight, i.e., parallel to the axis of rotation x, outer end and turbine blades 7′ having an outer end slanted by an angle β, are formed in alternation. It also should be apparent from FIG. 5 that the inner end of the slanted turbine blades 7′ also has an inclination. The inner terminal edge of the slanted turbine blades 7′ is not aligned with the axis of rotation x, in contrast to the inner end of the straight turbine blades.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A turbine wheel for a radial turbine, comprising:
a flow chamber,
a hub disk,
a cover disk, and
a plurality of turbine blades,
wherein the flow chamber is delimited by the hub disk and the cover disk, connects an inner opening to an outer opening and is subdivided by the plurality of turbine blades into flow channels, and
wherein two turbine blades of the plurality of turbine blades are adjacently disposed in a circumferential direction of the turbine wheel are slanted relative to each other.

2. The turbine wheel according to claim 1, wherein the two adjacently disposed turbine blades are slanted relative to each other at respective outer ends that adjoin the outer opening.

3. The turbine wheel according to claim 1, wherein the plurality of turbine blades includes full blades and splitter blades, wherein the full blades extend from the inner opening to the outer opening, and wherein splitter blades start with radial spacing from an inner end of the full blades and extend to the outer opening.

4. The turbine wheel according to claim 3, wherein the full blades are straight and the splitter blades are at least partially slanted.

5. The turbine wheel according to claim 1, wherein an inclination of a turbine blade, of the plurality of the turbine blades, varies in dependence on a distance from an axis of rotation (x) of the turbine wheel, about which axis of rotation (x) the turbine wheel is rotationally periodically formed.

6. The turbine wheel according to claim 5, wherein two adjacent turbine blades, of the plurality of the turbine blades, are slanted relative to each other at an inner or an outer end of at least of one of the two turbine blades and wherein the two adjacent turbine blades are not slanted relative to each other at an opposite end of at least of one of the two adjacent turbine blades.

7. The turbine wheel according to claim 1, wherein a flow cross-section of one of the flow channels, along an entire length of the one flow channel, is equal in size as a flow cross-section of an adjacent one of the flow channels.

8. The turbine wheel according to claim 1, where the hub disk, the cover disk or both is curved in a radial direction.

9. The turbine wheel according to claim 1, wherein the turbine blades of the plurality of turbine blades transition, in a rounded overhang, into the cover disk.
